(19) United States
(12) Patent Application Publication
(10) Pub. No.: US 2007/0128391 A1
(43) Pub. Date: Jun. 7, 2007

(54) Thermal insulating component and a garment, article of footwear, etc., provided with such component

(75) Inventors: Frederic Giacobone, Cusy (FR); Antoine Barthelemy, Annecy Le Vieux (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 11/633,565

(22) Filed: Dec. 5, 2006

(30) Foreign Application Priority Data
Dec. 6, 2005 (FR) 05.12334

(51) Int. Cl. B32B 27/08

(52) U.S. Cl. 428/35.7; 428/74; 428/76

(57) ABSTRACT

An insulating component having a layer of insulating material and a sealed envelope around the layer of insulating material, the envelope being is made of elastomer material. The envelope is sealed by a peripheral weld. In a particular exemplary embodiment, the insulating component is part of an article of footwear, in which the component is positioned between an outer layer and an inner layer of a liner and is assembled to the upper by a seam along the peripheral weld.

### CROSS-REFERENCE TO RELATED APPLICATION

This application is based upon French Patent Application No. 05.12334, filed Dec. 6, 2005, the disclosure of which is hereby incorporated by reference thereto in its entirety and the priority of which is hereby claimed under 35 U.S.C. §119.

### BACKGROUND OF THE INVENTION

1. Field of the Invention

The invention relates to a thermal insulating element for an article to be worn, such as a garment or an article of footwear, as well as to such an article, garment, or article of footwear provided with such an element. The invention also relates to a method of manufacturing such insulating element.

2. Description of Background and Relevant Information

Shoes or footwear adapted to be used in cold environments must have adequate thermal insulation to prevent the feet from becoming cold. For this purpose, winter shoes, particularly after-ski boots and mountain shoes adapted to winter or mountaineering use, are provided with linings or insulating liners, the latter being removable.

The toe area is a particularly cold-sensitive area of the foot. Indeed, blood circulation in this area can vary substantially, depending on the person and/or the type of physical activity.

Indeed, the plantar zone acts as a pump when pressure is applied. If the plantar zone remains still or if an insufficient pressure is applied thereto, blood circulation is not carried out adequately, and the toes, located beyond the plantar zone, are not sufficiently warmed up.

To overcome this drawback, the document DE 195 12 499 proposes adding a layer of non-compressible air-trapping material in the toe area only.

This layer of insulating material is sewn to the material of the shoe upper in the toe area, and is shaped with the upper during the conventional lasting operation. This type of construction is only provided for conventional lasting operations. Furthermore, in the case of a shoe required to be waterproof, or breathable-waterproof, the seams must be waterproof.

US 2005/0175799 discloses making a very thin insulating component having a greater thermal insulation than conventional materials and which can be incorporated into garments without substantially affecting the size and the outside appearance thereof.

The insulating component known from this document is made of a polyester, nylon polyamide, polyethylene gas-impervious envelope covered with a layer of reflecting material such as aluminum, which is vacuum sealed and inside which there are fine-powdered insulating materials such as silica, alumina, aerogel, and possibly a structural material made of fibers, for example polyester fibers, the vacuum being an excellent insulator because the lack of material prevents heat conduction.

Due to the vacuum-sealing and the use of highly insulative materials, such as aerogel, the insulating component has a very low thermal conductivity, less than 20 mW/mK.

The material thus produced is highly insulative, even in the form of a thin layer.

However, because it is vacuum-sealed, the insulating component according to US 2005/0175799 has the drawback of lacking flexibility and, therefore, lacking adaptability to the shape of the garment, especially the shape of a shoe.

For this reason, its thickness is reduced and maintained to values lower than 2 or 3 millimeters (mm).

Even with such thicknesses, the insulating component remains hardly flexible.

This problem is amplified at low temperature, when the polyester, nylon, and polyethylene materials used to make the envelope harden, which makes them brittle, and, therefore, such a component is not adapted for use in a shoe, for example a walking shoe, a running shoe, a mountain boot, or a cross-country ski boot, in which the repeated rolling/flexing movements of the foot can cause the envelope to break. Furthermore, the envelope is not actually entirely gas-impervious and slowly allows air to get through, so that the vacuum slowly disappears and the insulating component loses its thermal insulation properties provided by the vacuum. In addition, the envelope “inflates” due to air penetration and also loses its thinness, which proportionally reduces the volume available to the wearer and especially the interior of the shoe.

### SUMMARY OF THE INVENTION

The invention overcomes the aforementioned drawbacks.

To this end, the invention provides a new thermal insulation concept for garments, footwear, and/or other articles that can be worn.

Further, the invention provides a thermal insulation concept that is compatible with uses at very low temperature, especially at temperatures lower than −20° C.

Still further, the invention provides new type of insulating component which can easily conform to the shape of the object into which it is to be incorporated.

The aforementioned aspects of the invention are achieved with the insulating component according to the invention because the component includes the following:

a layer of insulating material;

a sealed envelope around the layer of insulating material;

the envelope being made of elastomeric material and/or of an elastomer-based material.

In the context of the invention, elastomeric materials are defined as being natural or synthetic polymers having elastic properties that are similar to those of rubber, and therefore elastic at room temperature. Elastomeric material-based materials or elastomer-based materials are defined in the context of the invention as elastomer-based and/or elastomerized composite materials, meaning, mixed with an elastomer plasticizer and having elastic properties similar to those of rubber. These materials retain at least part of these elastic properties, even at low temperature, and therefore remain flexible and non-brittle, even at temperatures on the order of −20° C. and below.

In addition, the use of elastic materials for the envelope of the insulating component allows for easily adapting the component to the shape of the object into which it is to be incorporated.

The fact that the envelope is airtight also enables using, as either main or complementary insulating material, powdered materials, such as aerogel or silica powder, which are highly insulative yet volatile due to their powder structure.

Finally, the use of elastomer materials or elastomer-based materials for the envelope makes it entirely waterproof, prevents damage to the insulation due to humidity, and allows for a better manipulation during the manufacture, especially when powder materials are used.

The invention also relates to the method for manufacturing such an insulating component as well as to its application to various objects.

### BRIEF DESCRIPTION OF DRAWINGS

The invention will be better understood from the description that follows, with reference to the annexed drawings showing several embodiments by way of non-limiting examples, in which:

FIG. 1 is a perspective view of an article of footwear incorporating an insulating component according to the invention;

FIG. 2 is a view similar to that of FIG. 1, with a partial cut-away, showing the positioning of the insulating component;

FIGS. 2A and 2B are enlarged detailed views of FIG. 2;

FIG. 3 is an exploded perspective view showing the construction of an insulating material;

FIG. 3A is a schematic partial cross-sectional view of a device for manufacturing a particular embodiment;

FIG. 4 is a perspective view of the finished insulating component;

FIG. 5 is a view, similar to FIG. 4, of an insulating material according to another embodiment; and

FIG. 6 is a perspective view of a helmet incorporating an insulating component according to the invention.

### DETAILED DESCRIPTION OF THE INVENTION

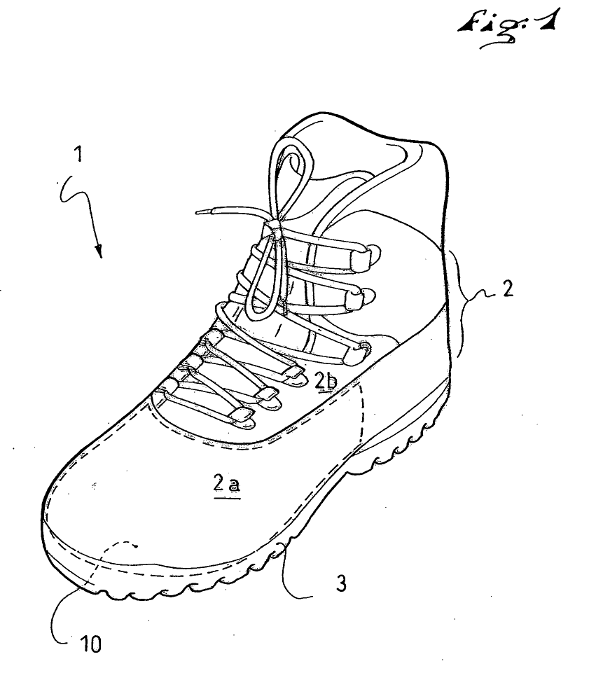

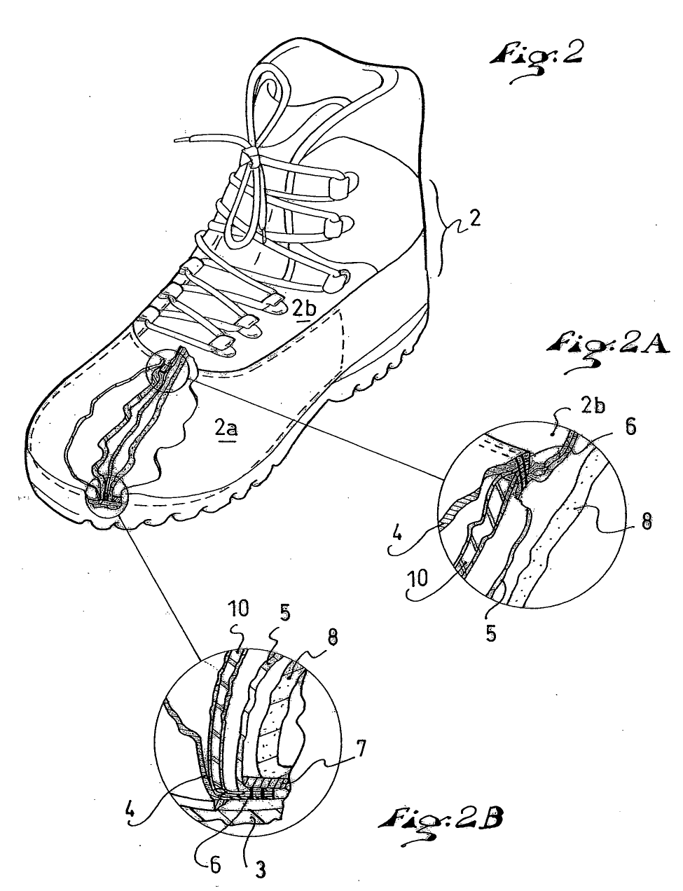

FIGS. 1 and 2 illustrate a boot 1 having an upper 2 and an outer sole 3, as well as an insulating component 10 according to the invention, shown in broken lines in FIG. 1.

In the embodiment shown, the insulating component or element 10 is provided in the forefoot area of the boot. It could also be provided only in the toe area or toe cap of the boot and/or in the heel area and/or in the entire upper.

The toe/forefoot area, however, is a preferred area for such an insulating element because it is the foot area that is the most sensitive to cold.

FIGS. 2, 2A, and 2B show more precisely a position of the insulating element 10 in the forefoot portion 2a of the upper 2.

The upper 2 includes in the forefoot area 2a, from the outside to the inside, an outer envelope 4, an insulating element 10, and a lining 5.

These various elements 4, 5, 10 are assembled together by means of a peripheral seam 6, such as stitching. As shown in FIG. 2A, the seam 6 also allows assembling those elements to the portion 2b of the upper bearing the lacing or tightening system. The assembly is then assembled to the sole, such as the insole 7, in a manner of assembly, known per se.

A complementary insulating liner 8 can be provided inside the article of footwear, as shown in FIGS. 2A, 2B.

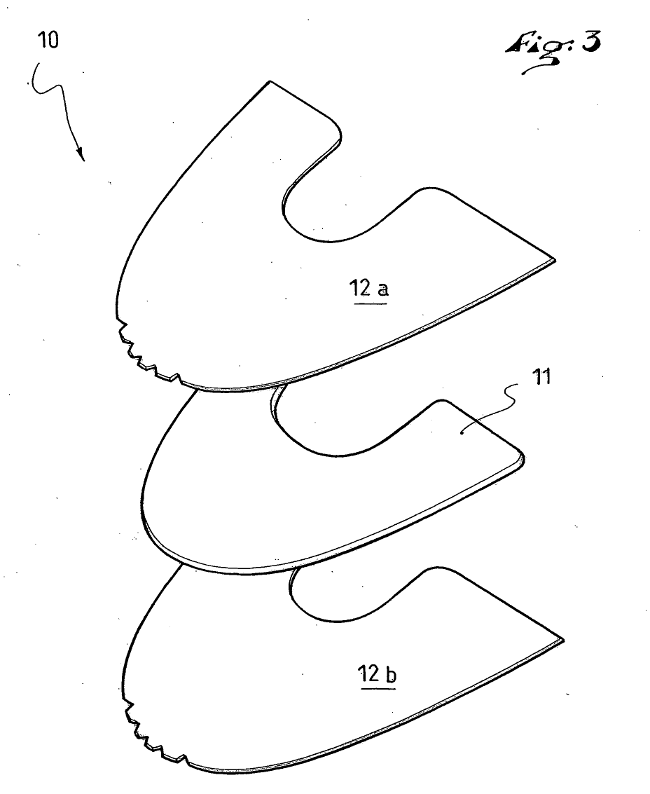

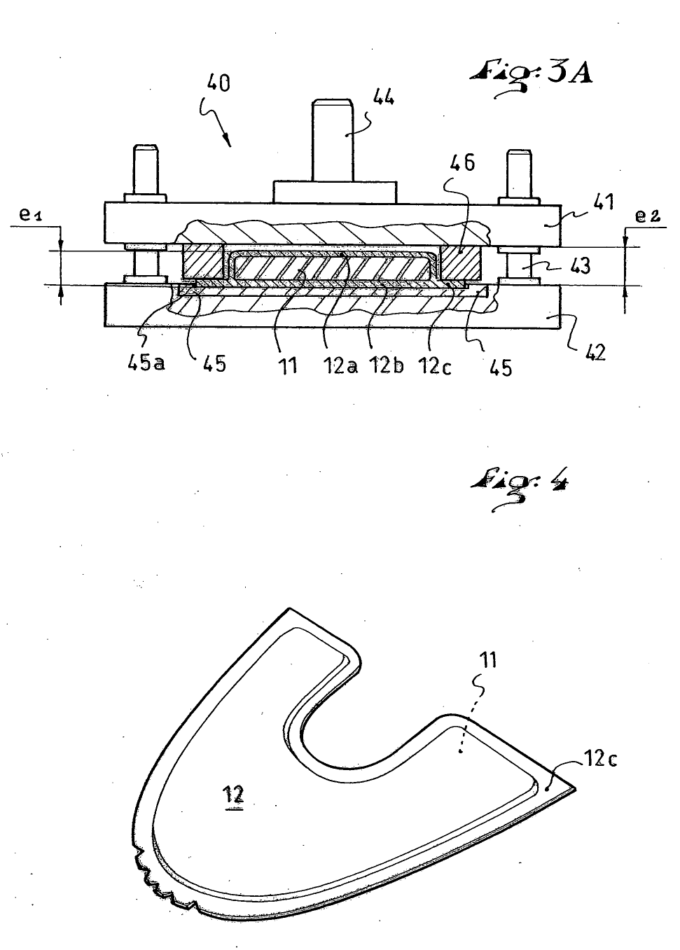

FIGS. 3, 3A, and 4 show the structure of an insulating element 10 according to the invention.

More particularly, the insulating element 10 includes a layer of insulating material 11 substantially U-shaped, in this case, and inserted inside an envelope 12. The envelope 12 is made of two films 12a, 12b of elastomer materials cut in a U shape similar to that of the layer 11, but with slightly greater dimensions, as can be seen in FIGS. 3 and 4 in particular.

The two films 12a, 12b are positioned on opposite sides of the layer of insulating material 11 and are then sealed thereon by peripheral heat welding 12c so as to form an envelope.

The films 12a, 12b are made of elastomer material and therefore are waterproof. The material can be polyurethane, silicone, rubber, or any other elastomer material or elastomer-based composite material or elastomer having a bending modulus of less than 500 MPa. The films 12a, 12b, can be made of composite materials comprising a layer of elastic fabric, for example with Spandex fibers or known under the trademark Lycra®, coated with a layer of elastomer material such as polyurethane, to make them waterproof. An elastomerized material, such as elastomerized PVC, can also be utilized.

These elastomer materials being waterproof, the envelope 12 thus produced is completely waterproof, so that the insulating material 11 placed inside the envelope is protected from moisture and does not risk losing its thermal properties.

In addition, the waterproofness of the envelope 12 is very simply achieved by means of the peripheral welding 12c and does not require the additional requirement of sealing tape, as is the case with stitched seams, or other measure.

FIG. 3A shows a press device 40 for carrying out the peripheral welding.

The press 40 is a hot press of known type comprising two heating plates, i.e., an upper plate 41 and a lower plate 42, respectively. In the illustrated example, the lower plate 42 is fixed whereas the upper plate 41 is moveable. Two guide pins 43, positioned on each side of the lower plate 42 and slidably mounted in the upper plate 41, ensure a good relative positioning of the two plates during their respective movements. Depending on the type of press, these guide pins could be omitted. The fixed and moveable plates can also be inverted. A jack 44 ensures the movement of the upper plate. The two plates 41, 42 can be heated to a temperature ranging between 100° C. and 200° C.

On the lower plate 42 is arranged a positioning device 45, defining a cavity 45a having a shape complementary to that of the envelope 12 so as to ensure correct positioning.

As the case may be, and depending on the shape of the envelope, the positioning device 45 can be omitted, the envelope 12 then being simply laid flat on the lower plate 42.

On the lower surface of the upper plate 41 is fixed a curb or guide 46, in the shape of the peripheral weld 12c, in this case a recessed shape in the form of a horseshoe. It is the cooperation of the guide 46 with the lower heating plate 42 that makes it possible to achieve the peripheral welding 12c. The height of the guide 46 is provided so that the distance e2 between the two heating plates 41, 42 at the time the pressing operation occurs is greater than the thickness e1 of the insulating element 10, and therefore greater than the thickness of the insulating material 11 itself and of the two envelope layers 12a, 12b.

This construction or arrangement of the conventional pressing device guarantees that the insulating material 11 itself is not compressed by the press during the envelope peripheral welding phase, and that it therefore keeps optimal insulating properties.

The press device shown and described can be modified as long as the insulating material is not compressed during the welding phase and only the periphery of the envelope is subject to pressure during this phase.

In practice, in a particular non-limiting example, the peripheral welding for a polyurethane envelope can be carried out at a 120° C. temperature for 20 seconds, at 3-bar pressure. Depending on the materials used for the envelope, the welding can also be carried out by inserting a glue film, for example polyurethane glue.

The welding can also be carried out with indirect heat using, for example, high-frequency welding or similar methods. With high-frequency welding, the operation for a polyurethane envelope can be carried out at a temperature of 70° C. to 80° C., at a 6-bar pressure for 18 seconds or approximately 18 seconds.

Once manufactured, the insulating element 10 can be fixed where desired on the upper, such as in the forefoot area 2a, in the example shown, by means of the seam 6, made in the area of the peripheral welding 12c, so as not to negatively affect waterproofness.

As previously indicated, the seam 6 also allows for simultaneously assembling to another portion 2b of the upper 2 and/or to the liner 5 thereof. This assembly of the various elements of the upper 2 is a flat assembly, as known per se.

In a known manner, the upper 2 is then fitted and shaped onto a last, and fixed in the desired shape on the last by means of the insole 7. The assembly is then fixed to the outer sole 3, for example by gluing, with an adequate drying time, before the last is removed.

Shaping the upper poses no problem, even with the insulating element, due to the fact that the envelope 12 of the insulating element is made of elastomer material, and is therefore elastic.

In practice, good results can be achieved with an insulating material made of polyester textile felt.

In addition, the insulating material encapsulation by means of the waterproof envelope 12 enables the use of insulating materials, the insulation properties of which are reinforced by nanometric-powder aerogel material such as silica, carbon, or titanium powder. This type of material is also referred to as super insulant and is sold, for example, under the trademark Aspen Aerogel®.

Indeed, the peripheral welding 12c of the insulating element 10 prevents any powder leak during the manufacture of the item to be insulated or during its later use, and thus ensures the thermal longevity of the insulating element thus made.

As indicated above, the waterproof encapsulation also protects the insulation from water and moisture that could come either from the inside (foot perspiration), or from the outside, and therefore also ensures the efficiency of the achieved thermal insulation.

In addition, elastomer materials, used for the envelope, especially polyurethane, still maintain a certain flexibility even at very low temperature, for example on the order of −20° C. and below, and thus can be used in shoes subjected to repeated bending, without any problem. Therefore, great results can be achieved using an envelope made of polyurethane film.

The fact that the insulating element thus produced maintains a certain flexibility, even at very low temperature, enables its use in products requiring such flexibility, such as gloves, shoes, etc.

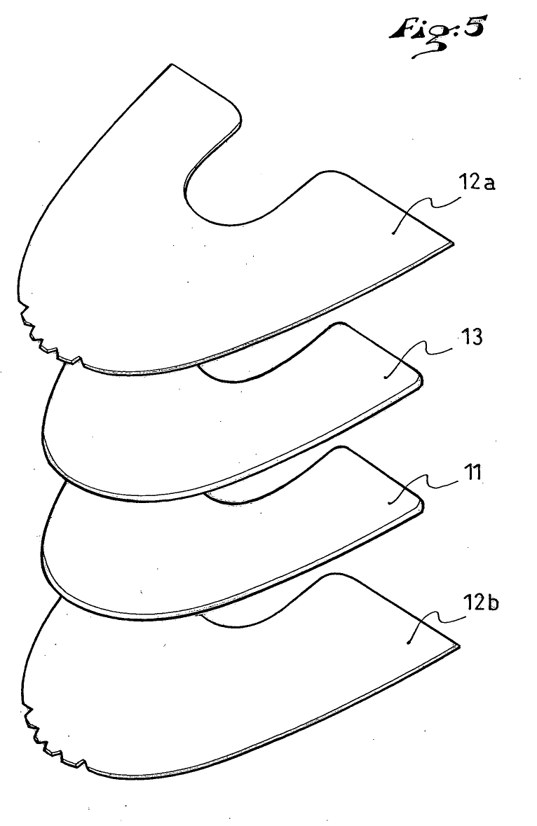

In addition to the envelope layers 2a, 12b made of elastomer and the layer of insulating material 11, FIG. 5 shows another embodiment in which the insulating element 10 has a fourth layer 13 made of thermoplastic material such as polyethylene/polypropylene known under the trademark TEXON®, and commonly used to make the safety toe caps and counters. Thermosetting materials, depending on the type of counters desired, can also be considered. In this case, one of the envelope layers, for example 12a, can be removed and replaced by the layer 13 made of thermoplastic material, inasmuch as this material is waterproof and compatible for gluing with the envelope layer 12a, if the latter is made of polyurethane.

The insulating element 10 therefore allows the function of a safety toe cap to be combined with function of thermal insulation, in this case the insulating element 10 not extending over the entire forefoot zone, but being limited to the toe area.

In this case and as needed, two layers of thermoplastic/thermosetting materials can be provided. This is also valid for the layer 11 of insulating material, which can be doubled and/or made thicker as needed.

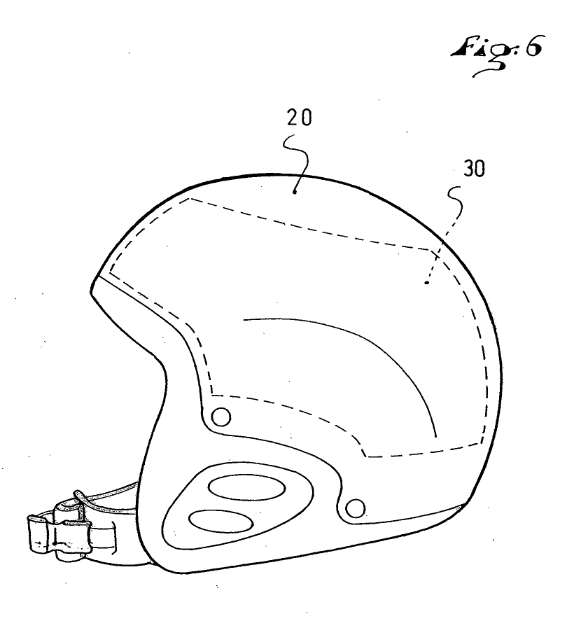

FIG. 6 shows another application of the invention in the form of producing thermal insulation of a helmet. The helmet has, in a known manner, a semi-spherical outer envelope 20 made of rigid material and an inner layer of shock-absorbing material (not shown in the drawing).

The helmet also has an additional layer 30, substantially crown-shaped, made of an insulating element according to the invention and arranged in the frontal, temporal, and occipital zone.

The application of the invention to helmets or to any other protective devices, such as a knee-pad, an elbow-pad, etc., is also advantageous due to the deformation of the insulating material required for successfully adapting to the morphology of the user's head or other body part.

The use of an aerogel material as an insulator is particularly advantageous in the case where the invention applies to a protective system because such material also has great shock absorption properties. Indeed, the nanometric structure, which slows down air circulation, thus providing thermal insulation characteristics, also slows down wave propagation, thus providing better shock absorption.

The invention is not limited to the particular embodiments described above, which have been presented as non-limiting examples, but rather encompasses all similar or equivalent embodiments.

The invention applies to all types of products for which identical or similar drawbacks are to be overcome.

1. An insulating component comprising:
a layer of insulating material;
a sealed envelope extending around the layer of insulating material;
the envelope being made of at least one of the following materials:
an elastomer material;
an elastomerized material;
an elastomer-based material.

2. An insulating component according to claim 1, wherein:
the envelope is made of a waterproof material.

3. An insulating component according to claim 1, wherein:
the envelope is sealed by means of a peripheral weld.

4. An insulating component according to claim 1, wherein:
the at least one material of the envelope has a bending modulus of less than 500 MPa.

5. An insulating component according to claim 1, wherein:
the envelope is an elastomer-based material selected from one of the following: polyurethane, silicone, and rubber.

6. An insulating component according to claim 1, wherein:
the insulating material comprises a structural layer having ultra-insulating particles.

7. An insulating component according to claim 6, wherein:
the structural layer is felt.

8. An insulating component according to claim 6, wherein:
the ultra-insulating particles comprise aerogel.

9. An insulating component according to claim 1, wherein:
the envelope is made of an elastic fabric covered with a layer of elastomer material.

10. A method for manufacturing an insulating component comprising:
arranging a layer of insulating material between two plates of a heating press, said layer being positioned between two envelope layers; and
applying a pressure and a welding temperature, with said heating press, for predetermined time only at a periphery of the envelope layers to make a peripheral weld at said periphery.

11. An insulating component manufactured by the method of claim 10.

12. An article of footwear comprising:
an upper provided with an insulating component;
said insulating component comprising:
a layer of insulating material;
an envelope extending around the layer of insulating material, said envelope being sealed by means of a peripheral weld;
the envelope being made of at least one of the following materials:
an elastomer material;
an elastomerized material;
an elastomer-based material;
a liner or lining comprising an outer layer and an inner layer;
said insulating component being positioned between said outer and inner layers of said liner or lining;
said insulating component being mounted to a remainder of said upper by means of a seam extending along said peripheral weld of said envelope.

13. An article of protection for a person's body, said article comprising:
an outer envelope made of a rigid material adapted to cover a body part;
an insulating component positioned inside of said outer envelope, said insulating component comprising:
a layer of insulating material;
an envelope extending around the layer of insulating material, said envelope being sealed by means of a peripheral weld;
the envelope being made of at least one of the following materials:
an elastomer material;
an elastomerized material;
an elastomer-based material.

14. An article of protection according to claim 13, wherein:
said article of protection is a helmet adapted to cover a person's head.

15. A garment comprising:
an outer envelope adapted to cover a body part;
an insulating component positioned inside of said outer envelope, said insulating component comprising:
a layer of insulating material;
an envelope extending around the layer of insulating material, said envelope being sealed by means of a peripheral weld;
the envelope being made of at least one of the following materials:
an elastomer material;
an elastomerized material;
an elastomer-based material.

16. A garment according to claim 15, wherein:
said garment is a glove, said outer envelope being adapted to cover a person's hand.
